(19) United States
(12) Patent Application Publication
(10) Pub. No.: US 2020/0092070 A1
(43) Pub. Date: Mar. 19, 2020

(54) SIGNALING DESIGN FOR MULTIPLE APERIODIC CSI FEEDBACK

(71) Applicants: Liangming WU, San Diego, CA (US); Wanshi CHEN, San Diego, CA (US); Yu ZHANG, San Diego, CA (US); Chao WEI, San Diego, CA (US); Chenxi HAO, San Diego, CA (US); QUALCOMM Incorporated, San Diego, CA (US)

(72) Inventors: Liangming Wu, Beijing (CN); Wanshi Chen, San Diego, CA (US); Yu Zhang, Beijing (CN); Chao Wei, Beijing (CN); Chenxi Hao, Beijing (CN)

(21) Appl. No.: 16/615,562

(22) PCT Filed: Jun. 12, 2018
(86) PCT No.: PCT/CN2018/090787

§ 371 Date: Nov. 21, 2019

(30) Foreign Application Priority Data
Jun. 16, 2017 (CN) PCT/CN2017/088665

(51) Int. Cl. H04L 5/00

(52) U.S. Cl. CPC H04L 5/0057; H04L 5/0007

(57) ABSTRACT

A signaling design for multiple aperiodic channel state information (M-A-CSI) feedback is disclosed. In new radio (NR) networks, there may be scenarios where M-A-CSI are triggered and reported simultaneously. Timing issues may arise because of the different delay periods for difference CSI processes and reporting. In a first aspect, a general set of delay times for the M-A-CSI maybe signaled to the user equipment (UE) from which a candidate set is selected by the UE based on various CSI related settings. An indication from the base station may then be used to select the delay from the candidate set. In a second aspect, a delay period may be selected from the set of delays associated with and corresponding to the M-A-CSI.

### CROSS-REFERENCE TO RELATED APPLICATIONS

This application claims the benefit of CN App. No.: PCT/CN2017/088665, entitled, “SIGNALING DESIGN FOR MULTIPLE APERIODIC CSI FEEDBACK,” filed on Jun. 16, 2017, which is expressly incorporated by reference herein in its entirety.

### BACKGROUND

### Field

Aspects of the present disclosure relate generally to wireless communication systems, and more particularly, to a signaling design for multiple aperiodic channel state information (CSI) feedback.

### Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

In one aspect of the disclosure, a method of wireless communication, includes obtaining a set of feedback delay periods corresponding to multiple aperiodic channel state information (M-A-CSI) reporting, receiving a request to generate M-A-CSI feedback, selecting a subset of the set of feedback delay periods, wherein the subset is selected according to configuration of one or more CSI-related settings associated with the M-A-CSI reporting, and receiving a downlink control signal indicating a delay period selected from the subset of delay periods for transmission of the M-A-CSI feedback after the trigger.

In an additional aspect of the disclosure, a method configured for wireless communications, includes receiving a request to generate M-A-CSI feedback, selecting a delay period for transmission of the M-A-CSI feedback after the request, wherein the delay period is selected from a plurality of delay periods corresponding to a plurality of A-CSI processes of the M-A-CSI feedback, generating the M-A-CSI feedback, and transmitting the M-A-CSI feedback to a base station after expiration of the delay period from the request.

In air additional aspect of the disclosure, an apparatus configured for wireless communications, includes means for obtaining a set of feedback delay periods corresponding to M-A-CSI reporting, means for receiving a request to generate M-A-CSI feedback, means for selecting a subset of the set of feedback delay periods, wherein the subset is selected according to configuration of one or more CSI-related settings associated with the M-A-CSI reporting, and means for receiving a downlink control signal indicating a delay period selected from the subset of delay periods for transmission of the M-A-CSI feedback after the trigger.

In an additional aspect of the disclosure, an apparatus configured for wireless communications, includes means for receiving a request to generate M-A-CSI feedback, means for selecting a delay period for transmission of the M-A-CSI feedback after the request, wherein the delay period is selected from a plurality of delay periods corresponding to a plurality of A-CSI processes of the M-A-CSI feedback, means for generating the M-A-CSI feedback, and means for transmitting the M-A-CSI feedback to a base station after expiration of the delay period from the request.

In an additional aspect of the disclosure, a non-transitory computer-readable medium having program code recorded thereon. The program code further includes code to obtain a set of feedback delay periods corresponding to M-A-CSI reporting, code to receive a request to generate M-A-CSI feedback, code to select a subset of the set of feedback delay periods, wherein the subset is selected according to configuration of one or more CSI-related settings associated with the M-A-CSI reporting, and code to receive a downlink control signal indicating a delay period selected from the subset of delay periods for transmission of the M-A-CSI feedback after the trigger.

In an additional aspect of the disclosure, a non-transitory computer-readable medium having program code recorded thereon. The program code further includes code to receive a request to generate M-A-CSI feedback, code to select a delay period for transmission of the M-A-CSI feedback after the request, wherein the delay period is selected from a plurality of delay periods corresponding to a plurality of A-CSI processes of the M-A-CSI feedback, code to generate the M-A-CSI feedback, and code to transmit the M-A-CSI feedback to a base station after expiration of the delay period from the request.

In an additional aspect of the disclosure, an apparatus configured for wireless communication is disclosed. The apparatus includes at least one processor, and a memory coupled to the processor. The processor is configured to obtain a set of feedback delay periods corresponding to M-A-CSI reporting, to receive a request to generate M-A-CSI feedback, to select a subset of the set of feedback delay periods, wherein the subset is selected according to configuration of one or more CSI-related settings associated with the M-A-CSI reporting, and to receive a downlink control signal indicating a delay period selected from the subset of delay periods for transmission of the M-A-CSI feedback after the trigger.

In an additional aspect of the disclosure, an apparatus configured for wireless communication is disclosed. The apparatus includes at least one processor, and a memory coupled to the processor. The processor is configured to receive a request to generate M-A-CSI feedback, to select a delay period for transmission of the M-A-CSI feedback after the request, wherein the delay period is selected from a plurality of delay periods corresponding to a plurality of A-CSI: processes of the M-A-CSI feedback, to generate the M-A-CSI feedback, and to transmit the M-A-CSI feedback to a base station after expiration of the delay period from the request.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system.

FIG. 2 is a block diagram illustrating a design of a base station and a UE configured according to one aspect of the present disclosure.

FIG. 3 is a block diagram illustrating a wireless communication system including base stations that use directional wireless beams.

FIG. 4 is a block diagram illustrating an aperiodic channel state information (A-CSI) feedback operation between a base station and UE.

FIG. 5 is a block diagram illustrating example blocks executed to implement one aspect of the present disclosure.

FIG. 6 is a block diagram illustrating example blocks executed to implement one aspect of the present disclosure.

FIG. 7 is a block diagram illustrating a multiple A-CSI (M-A-CSI) feedback operation between a base station and UE.

FIG. 8 is a block diagram illustrating an example UE configured according to aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., 1 ms), and users with wide ranges of mobility or lack thereof; and (3) with enhanced mobile broadband including extreme high capacity (e.g., ˜10 Tbps/km.²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

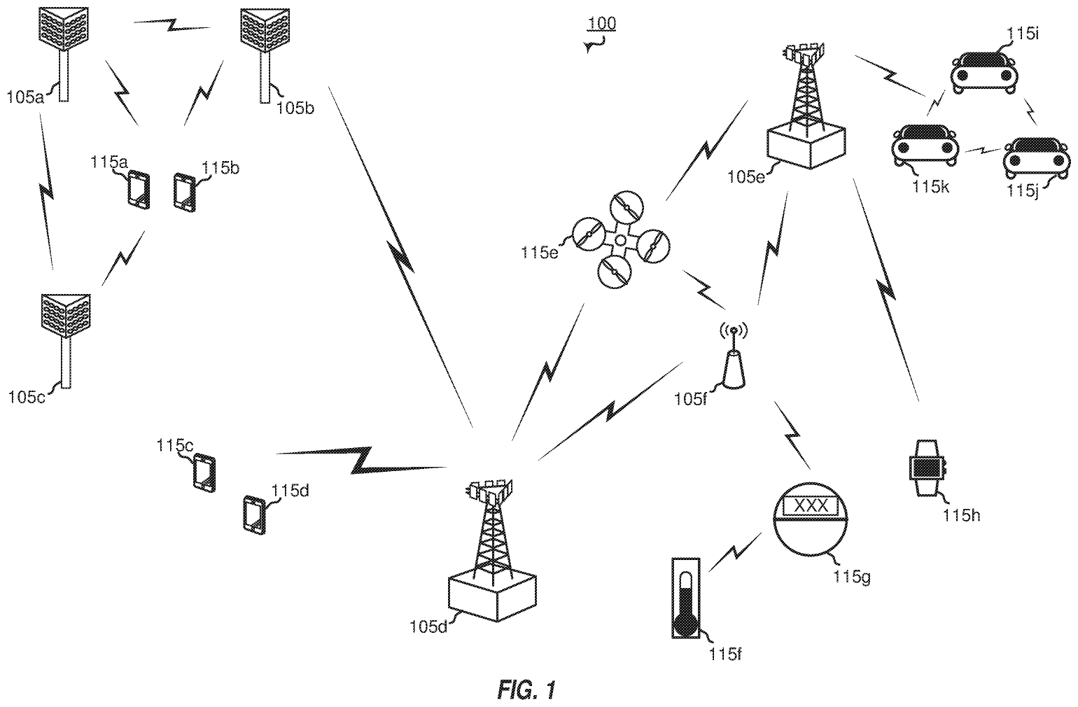

FIG. 1 is a block diagram illustrating 5G network 100 including various base stations and UEs configured according to aspects of the present disclosure. The 5G network 100 includes a number of base stations 105 and other network entities. A base station may be a station that communicates with the UEs and may also be referred to as an evolved node (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term used.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, the base stations 105d and 105e are regular macro base stations, while base stations 105a-105c are macro base stations enabled with one of 3 dimension. (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

The 5G network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time.

The UEs 115 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE may be a device that includes a Universal integrated Circuit Card (UICC). In another aspect, a UE may be a device that does not include a UICC. In some aspects, UEs that do not include UICCs may also be referred to as internet of everything (IoE) devices. UEs 115a-115d are examples of mobile smart phone-type devices accessing 5G network 100 A UE may also be a machine specifically configured for connected communication, including machine type communication (MTC), enhanced MTC (eMTC), narrowband IoT (NB-IoT) and the like. UEs 115e-115k are examples of various machines configured for communication that access 5G network 100. A UE may be able to communicate with any type of the base stations, whether macro base station, small cell, or the like. In FIG. 1, a lightning bolt (e.g., communication links) indicates wireless transmissions between a UE and a serving base station, which is a base station designated to serve the UE on the downlink and/or uplink, or desired transmission between base stations, and backhaul transmissions between base stations.

In operation at 5G network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

5G network 100 also support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through 5G network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. 5G network 100 may also provide additional network efficiency through dynamic, low-latency TDD/FDD communications, such as in a vehicle-to-vehicle (V2V) mesh network between UEs 115i-115k communicating with macro base station 105e.

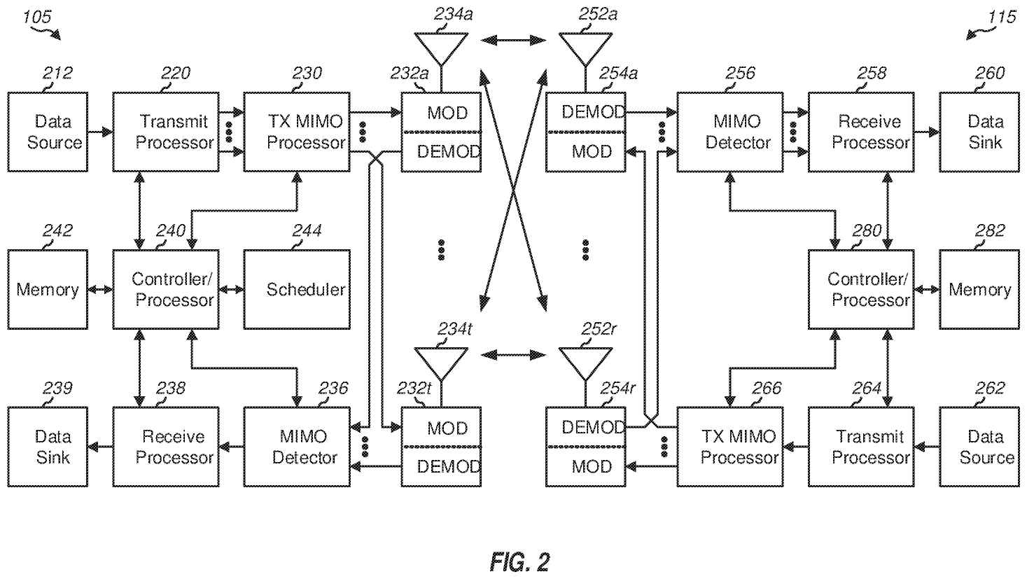

FIG. 2 shows a block diagram of a design of a base station 105 and a UE 115, which may be one of the base station and one of the UEs in FIG. 1. At the base station 105, a transmit processor 220 may receive data from a data source 212 and control information from a controller/processor 240. The control information may be for the PBCH, PCFICH, PHICH, PDCCH, EPDCCH, MPDCCH etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the PSS, SSS, and cell-specific reference signal. A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODS) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition. (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the modulators 254a through 254r (e.g., for SC-FDM, etc.), and transmitted to the base station 105. At the base station 105, the uplink signals from the UE 115 may be received by the antennas 234, processed by the demodulators 232, detected by a MIMO detector 236 if applicable, and further processed by a receive processor 238 to obtain decoded data and control information sent by the UE 115. The processor 238 may provide the decoded data to a data sink 239 and the decoded control information to the controller/processor 240.

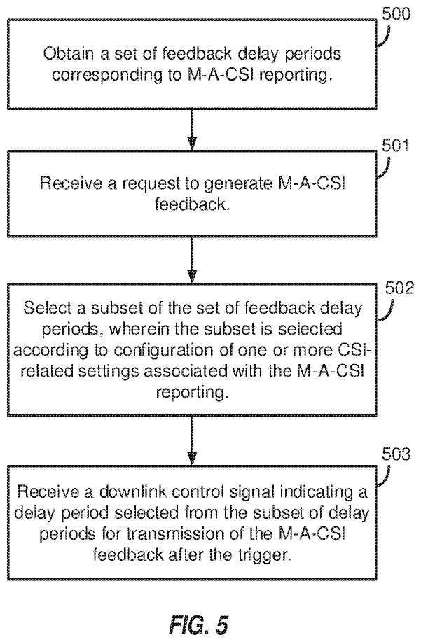

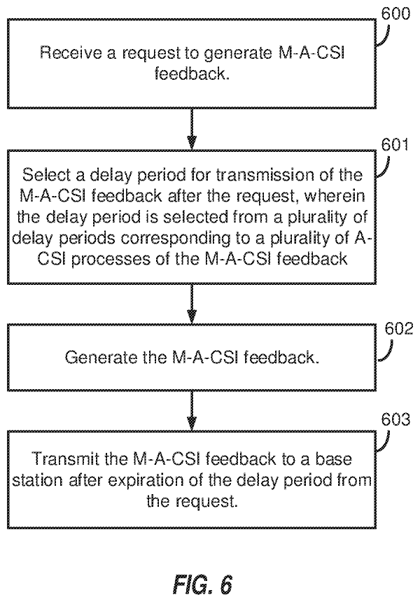

The controllers/processors 240 and 280 may direct the operation at the base station 105 and the UE 115, respectively. The controller/processor 240 and/or other processors and modules at the base station 105 may perform or direct the execution of various processes for the techniques described herein. The controllers/processor 280 and/or other processors and modules at the UE 115 may also perform or direct the execution of the functional blocks illustrated in FIGS. 5 and 6, and/or other processes for the techniques described herein. The memories 242 and 282 may store data and program codes for the base station 105 and the UE 115, respectively. A scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, LIE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

Use of a medium-sensing procedure to contend for access to an unlicensed shared spectrum may result in communication. inefficiencies. This may be particularly evident when multiple network operating entities (e.g., network operators) are attempting to access a shared resource. In 5G network 100, base stations 105 and UEs 115 may be operated by the same or different network operating entities. In some examples, an individual base station 105 or UE 115 may be operated by more than one network operating entity. In other examples, each base station 105 and UE 115 may be operated by a single network operating entity. Requiring each base station 105 and UE 115 of different network operating entities to contend for shared resources may result in increased signaling overhead and communication latency.

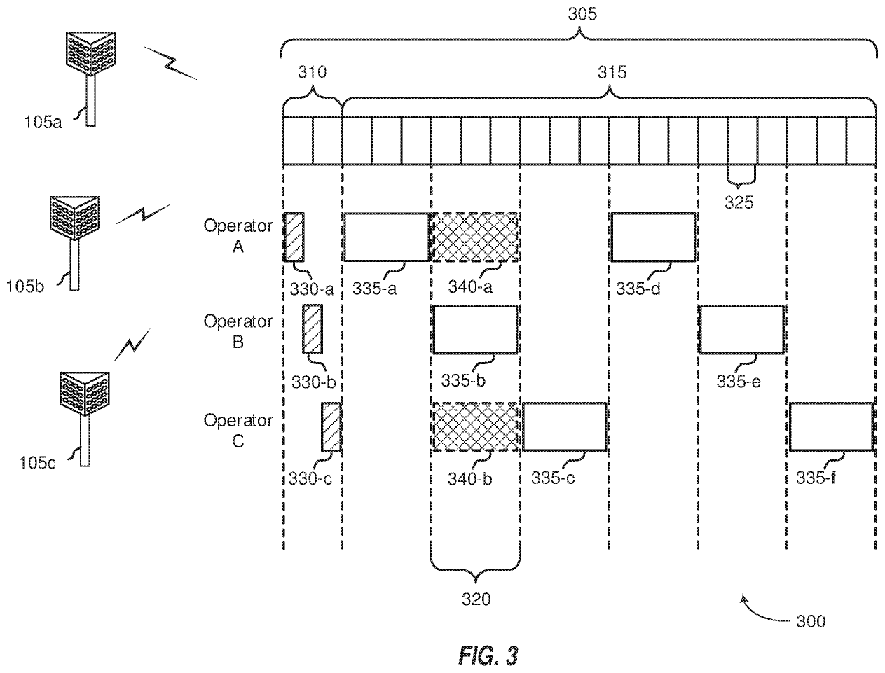

FIG. 3 illustrates an example of a timing diagram 300 for coordinated resource partitioning. The timing diagram 300 includes a superframe 305, which may represent a fixed duration of time (e.g., 20 ms). Superframe 305 may be repeated for a given communication session and may be used by a wireless system such as 5G network 100 described with reference to FIG. 1. The superframe 305 may be divided into intervals such as an acquisition interval (A-INT) 310 and an arbitration interval 315. As described in more detail below, the A-INT 310 and arbitration interval 315 may be subdivided into sub-intervals, designated for certain resource types, and allocated to different network operating entities to facilitate coordinated communications between the different network operating entities. For example, the arbitration interval 315 may be divided into a plurality of sub-intervals 320. Also, the superframe 305 may be further divided into a plurality of subframes 325 with a fixed duration (e.g., 1 ms). While timing diagram 300 illustrates three different network operating entities (e.g., Operator A, Operator B, Operator C), the number of network operating entities using the superframe 305 for coordinated communications may be greater than or fewer than the number illustrated in timing diagram 300.

The A-INT 310 may be a dedicated interval of the superframe 305 that is reserved for exclusive communications by the network operating entities. In some examples, each network operating entity may be allocated certain resources within the A-INT 310 for exclusive communications. For example, resources 330-a, may be reserved for exclusive communications by Operator A, such as through base station 105a, resources 330-b may be reserved for exclusive communications by Operator B, such as through base station 105b, and resources 330-c may be reserved for exclusive communications by Operator C, such as through base station 105c. Since the resources 330-a are reserved for exclusive communications by Operator A, neither Operator B nor Operator C can communicate during resources 330-a, even if Operator A chooses not to communicate during those resources. That is, access to exclusive resources is limited to the designated network operator. Similar restrictions apply to resources 330-b for Operator B and resources 330-c for Operator C. The wireless nodes of Operator A (e.g, UEs 115 or base stations 105) may communicate any information desired during their exclusive resources 330-a, such as control information or data.

When communicating over an exclusive resource, a network operating entity does not need to perform any medium sensing procedures (e.g., listen-before-talk (LBT) or clear channel assessment (CCA)) because the network operating entity knows that the resources are reserved. Because only the designated network operating entity may communicate over exclusive resources, there may be a reduced likelihood of interfering communications as compared to relying on medium sensing techniques alone (e.g., no hidden node problem). In some examples, the A-INT 310 is used to transmit control information, such as synchronization signals (e.g., SYNC signals), system information (e.g., system information blocks (SIBs)), paging information (e.g., physical broadcast channel (PBCH) messages), or random access information (e.g., random access channel (RACH) signals). In some examples, all of the wireless nodes associated with a network operating entity may transmit at the same time during their exclusive resources.

In some examples, resources may be classified as prioritized for certain network operating entities. Resources that are assigned with priority for a certain network operating entity may be referred to as a guaranteed interval (G-INT )for that network operating entity. The interval of resources used by the network operating entity during the G-INT may be referred to as a prioritized sub-interval. For example, resources 335-a may be prioritized for use by Operator A and may therefore be referred to as a G-INT for Operator A (e.g., G-INT-OpA). Similarly, resources 335-b may be prioritized for Operator B, resources 335-c may be prioritized for Operator C, resources 335-d may be prioritized for Operator A, resources 335-e may be prioritized for Operator B, and resources 335-f may be prioritized for operator C.

The various G-INT resources illustrated in FIG. 3 appear to be staggered to illustrate their association with their respective network operating entities, but these resources may all be on the same frequency bandwidth. Thus, if viewed along a time-frequency grid, the G-INT resources may appear as a contiguous line within the superframe 305. This partitioning of data may be an example of time division multiplexing (TDM). Also, when resources appear in the same sub-interval (e.g., resources 340-a and resources 335-b), these resources represent the same time resources with respect to the superframe 305 (e.g., the resources occupy the same sub-interval 320), but the resources are separately designated to illustrate that the same time resources can be classified differently for different operators.

When resources are assigned with priority for a certain network operating entity (e.g., a G-INT), that network operating entity may communicate using those resources without having to wait or perform any medium sensing procedures (e.g., LBT or CCA). For example, the wireless nodes of Operator A are free to communicate any data or control information during resources 335-a without interference from the wireless nodes of Operator B or Operator C.

A network operating entity may additionally signal to another operator that it intends to use a particular G-INT. For example, referring to resources 335-a, Operator A may signal to Operator B and Operator C that it intends to use resources 335-a. Such signaling may be referred to as an activity indication. Moreover, since Operator A has priority over resources 335-a, Operator A may be considered as a higher priority operator than both Operator B and Operator C. However, as discussed above, Operator A does not have to send signaling to the other network operating entities to ensure interference-free transmission during resources 335-a because the resources 335-a are assigned with priority to Operator A.

Similarly, a network operating entity may signal to another network operating entity that it intends not to use a particular G-INT. This signaling may also be referred to as an activity indication. For example, referring to resources 335-b, Operator B may signal to Operator A and Operator C that it intends not to use the resources 335-b for communication, even though the resources are assigned with priority to Operator B. With reference to resources 335-b, Operator B may be considered a higher priority network operating entity than Operator A and Operator C. In such cases, Operators A and C may attempt to use resources of sub-interval 320 on an opportunistic basis. Thus, from the perspective of Operator A, the sub-interval 320 that contains resources 335-b may be considered an opportunistic interval (O-INT) for Operator A (e.g., O-INT-OpA). For illustrative purposes, resources 340-a may represent the O-INT for Operator A. Also, from the perspective of Operator C, the same sub-interval 320 may represent an O-INT for Operator C with corresponding resources 340-b. Resources 340-a., 335-b, and 340-b all represent the same time resources (e.g., a particular sub-interval 320), but are identified separately to signify that the same resources may be considered as a G-INT for some network operating entities and yet as an O-INT for others.

To utilize resources on an opportunistic basis, Operator A and Operator C may perform medium-sensing procedures to check for communications on a particular channel before transmitting data. For example, if Operator B decides not to use resources 335-b (e.g., G-INT-OpB), then Operator A may use those same resources (e.g., represented by resources 340-a) by first checking the channel for interference (e.g., LBT) and then transmitting data if the channel was determined to be clear. Similarly, if Operator C wanted to access resources on an opportunistic basis during sub-interval 320 (e.g., use an O-INT represented by resources 340-b) in response to an indication that Operator B was not going to use its G-INT, Operator C may perform a medium sensing procedure and access the resources if available. In some cases, two operators (e.g., Operator A and Operator C) may attempt to access the same resources, in which case the operators may employ contention-based procedures to avoid interfering communications. The operators may also have sub-priorities assigned to them designed to determine which operator may gain access to resources if more than operator is attempting access simultaneously.

In some examples, a network operating entity may intend not to use a particular G-INT assigned to it, but may not send out an activity indication that conveys the intent not to use the resources. In such cases, for a particular sub-interval 320, lower priority operating entities may be configured to monitor the channel to determine whether a higher priority operating entity is using the resources. If a lower priority operating entity determines through LBT or similar method that a higher priority operating entity is not going to use its G-INT resources, then the lower priority operating entities may attempt to access the resources on an opportunistic basis as described above.

In some examples, access to a G-INT or O-INT may be preceded by a reservation signal (e.g., request-to-send (RTS)/clear-to-send (CTS)), and the contention window (CW) may be randomly chosen between one and the total number of operating entities.

In some examples, an operating entity may employ or be compatible with coordinated multipoint (CoMP) communications. For example an operating entity may employ CoMP and dynamic time division duplex (TDD) in a G-INT and opportunistic CoMP in an O-INT as needed.

In the example illustrated in FIG. 3, each sub-interval 320 includes a G-INT for one of Operator A, B, or C. However, in some cases, one or more sub-intervals 320 may include resources that are neither reserved for exclusive use nor reserved for prioritized use (e.g., unassigned resources). Such unassigned resources may be considered an O-INT for any network operating entity, and may be accessed on an opportunistic basis as described above.

In some examples, each subframe 325 may contain 14 symbols (e.g., 250-μs for 60 kHz tone spacing). These subframes 325 may be standalone, self-contained Interval-Cs (ITCs) or the subframes 325 may be a part of a long ITC. An ITC may be a self-contained transmission starting with a downlink transmission and ending with a uplink transmission. In some embodiments, an ITC may contain one or more subframes 325 operating contiguously upon medium occupation. In some cases, there may be a maximum of eight network operators in an A-INT 310 (e.g., with duration of 2 ms) assuming a 250-μs transmission opportunity.

Although three operators are illustrated in FIG. 3, it should be understood that fewer or more network operating entities may be configured to operate in a coordinated manner as described above. In some cases, the location of the G-INT, O-INT, or A-INT within superframe 305 for each operator is determined autonomously based on the number of network operating entities active in a system. For example, if there is only one network operating entity, each sub-interval 320 may be occupied by a G-INT for that single network operating entity, or the sub-intervals 320 may alternate between G-INTs for that network operating entity and O-INTs to allow other network operating entities to enter. If there are two network operating entities, the sub-intervals 320 may alternate between G-INTs for the first network operating entity and G-INTs for the second network operating entity. If there are three network operating entities, the G-INT and O-INTs for each network operating entity may be designed as illustrated in FIG. 3. If there are four network operating entities, the first four sub-intervals 320 may include consecutive G-INTs for the four network operating entities and the remaining two sub-intervals 320 may contain O-INTs. Similarly, if there are five network operating entities, the first five sub-intervals 320 may contain consecutive G-INTs for the five network operating entities and the remaining sub-interval. 320 may contain an O-INT. If there are six network operating entities, all six sub-intervals 320 may include consecutive G-INTs for each network operating entity. It should be understood that these examples are for illustrative purposes only and that other autonomously determined interval allocations may be used.

It should be understood that the coordination framework described with reference to FIG. 3 is for illustration purposes only. For example, the duration of superframe 305 may be more or less than 20 ms. Also, the number, duration, and location of sub-intervals 320 and subframes 325 may differ from the configuration illustrated. Also, the types of resource designations (e.g., exclusive, prioritized, unassigned) may differ or include more or less sub-designations.

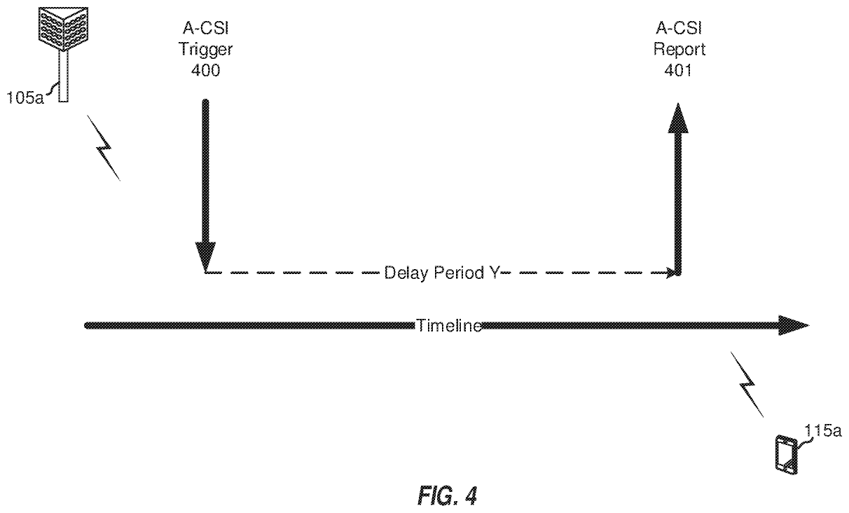

FIG. 4 is a block diagram illustrating an aperiodic channel state information (A-CSI) feedback operation between base station 105a and UE 115a. Base station 105a transmits an A-CSI trigger 400 to UE 115a. UE 115a performs the A-CSI processes to determine the CSI information and measurements. UE 11.5a would then report the resulting CSI information and measurement in A-CSI report 401, after a delay period, Y. For A-CSI reporting on PUSCH, the delay period, Y, may be indicated by the downlink control indicator (DCI). The DCI used for indicating the timing for PUSCH allocation may also be used to indicate the delay period, Y. The timing between uplink assignment and the corresponding PUSCH may be within the candidate set of values of the delay period, Y. This relationship applies without regard to the support decision for either or both cases of uplink control indicator (UCI) multiplexing with data on PUSCH and UCI only on PUSCH.

Timing between the uplink assignment and corresponding uplink data transmission may be indicated by a field in the DCI from a set of values. This set of values may be configured by higher layer signaling. The candidate set of values of delay periods, Y, may be selected according to restricted conditions inferred from configuration of CSI related settings. The conditions may include settings, such as CSI parameter; number of CSI-RS antenna ports if PMI is included; CSI-RS location; frequency granularity of CSI; and the like.

In NR multiple input, multiple output (NR-MIMO), for CSI reporting the delay period, Y, for CSI reporting may be fixed or configurable by the network but with a certain restriction on the lower value limit of the delay period to provide sufficient CSI computation time. Candidate values of the delay period may be fixed or pre-determined by various rules.

Scenarios exist in NR where multiple A-CSI (M-A-CSI) may be triggered and reported simultaneously. For example, multiple narrowband CSI may be jointly triggered, or multiple CSI process feedback may be needed for non-coherent CoMP transmission. If multiple A-CSI reporting are triggered simultaneously, there may be timing issues arising from the different timing requirements of the different CSI processes. More UE calculation may then be performed in order to deal with M-A-CSI.

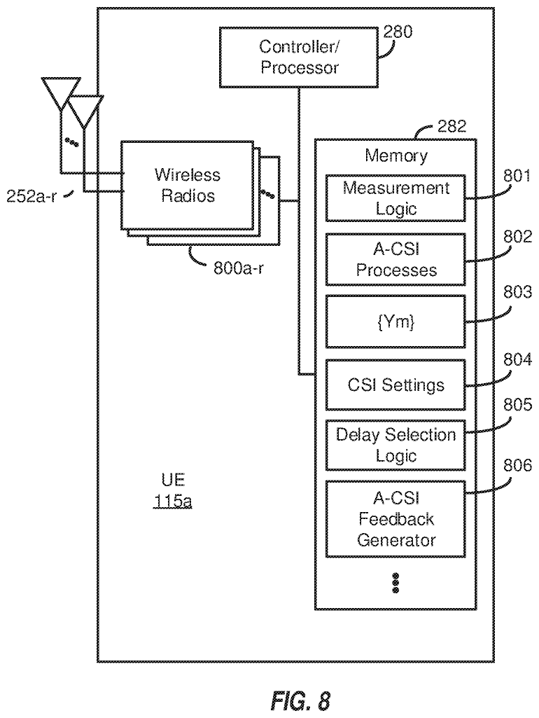

FIG. 5 is a block diagram illustrating example blocks executed to implement one aspect of the present disclosure. The example blocks will also be described with respect to UE 115 as illustrated in FIG. 8. FIG. 8 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 800a-r and antennas 252a-r. Wireless radios 800a-r includes various components and hardware, as illustrated in FIG. 2 for eNB 105, including modulator/demodulators 254a-r, MIMO detector 256, receive processor 258, transmit processor 264, and TX MIMO processor 266.

At block 500, a UE obtains a set of feedback delay periods corresponding to M-A-CSI reporting. For example, the set of delay period values, {Ym}, may be obtained by UE 115 via higher-layer signaling received from the serving base station via antennas 252a-r and wireless radios 800a-r or as predefined values. The delay period values would then be stored at {YM} 803 in memory 282. The set of delay period values may be received before any A-CSI operations are initiated. At block 501, the UE receives a request to generate M-A-CSI feedback. The request is received by UE 115 from its serving base station via antennas 252a-r and wireless radios 800a-r and requests UE 115 to perform multiple A-CSI processes for feedback data. Once the M-A-CSI request is initiated, UE 115, under control of controller/processor 280 determines the processing included to perform the M-A-CSI by accessing A-CSI processes 802 and executing measurement logic 801 to determine the various A-CSI feedback information.

At block 502, the UE selects a subset of the set of feedback delay periods, wherein the subset is selected according to configuration of one or more CSI-related settings associated with the M-A-CSI reporting. For example, UE 115, under control of controller/processor 280, executes delay selection logic 805, stored in memory 282. The execution environment of delay selection logic 805 allows UE 115 to select a candidate subset of delay period values, {Ymₛ}, from the original set of feedback delay periods, {Ym} 803. UE 115 selects the candidates according to various restricted conditions that may be inferred from configuration of CSI related settings within the M-A-CSI. The “CSI related settings” may be stored at CSI settings 804 in memory 282 and include such settings as: CSI parameter; number of CSI-RS antenna ports, if PMI is included; CSI-RS location; and frequency granularity of CSI. Such settings may be typical for determining delay of single A-CSI processes. However, in the present aspect, CSI settings 804 may also include the number of simultaneously CSI processes UE 115 is capable of, and UE 115 capability of CSI processing (such as the simultaneous support of the number of CSI processes). If the selection process does not rule out certain delay periods, then the selected subset may be equivalent to the set of delay period values obtained at block 500 ({Ymₛ}={Ym}).

At block 503, the UE receives a downlink control signal indicating a delay period selected from the subset of delay periods for transmission of the M-A-CSI feedback after the trigger. The downlink control signal received by UE 115 via antennas 252a-r and wireless radios 800a-r may include a DCI used to indicate the selection of Ym′ within the set {Ymₛ}. Ym′ indicates the selected the delay that UE 115 will use for M-A-CSI feedback after the triggering.

FIG. 6 is a block diagram illustrating example blocks executed to implement one aspect of the present disclosure. The example blocks will also be described with respect to UE 115 as illustrated in FIG. 8. In a second aspect, the delay period selected to use by UE 115, Ym′, may be selected from the collection of delay periods associated with the various CSI processes within the M-A-CSI that UE 115 is configured for, as stored at A-CSI processes 802. At block 600, a UE receives a request to generate M-A-CSI feedback. In the course of operation, UE 115 may receive requests from a serving base station via antennas 252a-r and wireless radios 800a-r for multiple A-CSI feedback. At block 601, the UE selects a delay period for transmission of the M-A-CSI feedback after the request, wherein the delay period is selected from a plurality of delay periods corresponding to a plurality of A-CSI processes of the M-A-CSI feedback. UE 115, under control of controller/processor 280, executes delay selection logic 805, stored in memory 282. The different A-CSI processes configured for the UE via the M-A-CSI feedback each include their own related delay period. The execution environment of delay selection logic 805 provides for U 115 to select the delay period, Ym′. The resulting delay period selected, Ym′, is selected from one of the delay periods associated with the A-CSI processes of the M-A-CSI.

At block 602, the UE generates the M-A-CSI feedback through various measurements and channel calculations and estimates. For example, UE 115, under control of controller/processor 280, performs the measurements by executing measurement logic 801 to determine the CSI associated with the A-CSI processes of the M-A-CSI. UE 115 executes A-CSI feedback generator 806 to compile the CSI feedback into a report. At block 603, the UE transmits the M-A-CSI feedback to the base station after expiration of the delay period from the request. For example, UE 115 transmits the generated A-CSI report and transmits the report to the serving base station via wireless radios 800a-r and antennas 252a-r. Once the request for M-A-CSI occurs, UE 115 will process the A-CSI processes to come up with the resulting feedback information. When the delay period expires after the request, UE 115 will transmit the feedback to the base station.

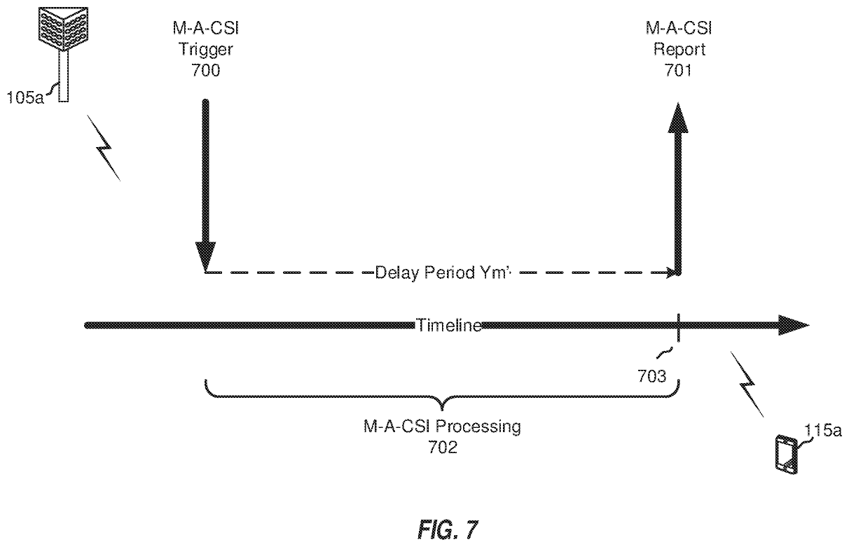

FIG. 7 is a block diagram illustrating a M-A-CSI feedback operation between a base station 105a and UE 115a configured according to one aspect of the present disclosure. In the described second aspect illustrated in FIG. 6, the ultimate selected delay period, Ym′, is selected from one of the delay periods associated with the A-CSI processes configured for UE 115a and part of the M-A-CSI request. In a first operational example of this second aspect, base station 105a indicates which CSI process's delay may be used as the delay of M-A-CSI. That is, of the multiple CSI processes of the M-A-CSI request, the indicated CSI process is j^{th} delay period within the 1˜k CSI processes of the M-A-CSI. This j^{th} CSI process delay is then used for all processes of the M-A-CSI. The indicator of which CSI process is selected could be provided to UE 115a via higher layer signaling or via DCI from base station 105a.

Accordingly, when base station 105a transmits M-A-CSI trigger 700 to UE 115a, UE 115a performs M-A-CSI processing 702 of the A-CSI processes included in the request. The delay period, Ym′, would then be selected by UE 115a based on an indication from base station 105a. The indicator from base station 105a identifies which of the A-CSI processes for UE 115a to select. The delay period, Ym′, corresponds to the delay associated with the selected A-CSI process. After expiration of the delay period at 703, UE 115a would transmit M-A-CSI report 701 to base station 105a.

In a second operational aspect of the second aspect, each CSI process's feedback delay may be indicated, but the maximum delay is selected by the UE. That is, the M-A-CSI delay is always selected as the maximum operator of the associated delay periods (max{Y₁, Y₂ . . . Yₘ} for a total m CSI feedbacks). The delay period of the maximum delay for the j^{th} CSI feedback Yⱼ can be indicated either via higher layer signaling or DCI selected from its own delay set {Yⱼ}. Thus, referring back to FIG. 7, of the multiple A-CSI processes that are part of M-A-CSI trigger 700, base station 105a signals the maximum delay for UE 115a to select as the delay period, Ym′.

In a third operational aspect, the base station uses a set of potential delay periods that is generated by the intersection of the delay of multiple CSI processes. That is, the new set Y_M is defined by the intersection of {Y₁ . . . Yₖ} for the total k CSI processes in M-A-CSI. The selection of the particular delay period to use, Ym′, can be indicated either via higher layer signaling or via DCI. Referring back to FIG. 7, base station 105a forms a new set of potential delay periods that is the intersection of all of the delay periods associated with each of the A-CSI processes included in the request of M-A-CSI trigger 700. Based on further signaling from base station 105a, UE 115a will select the applied delay period, Ym′, for each of the A-CS I processes for the M-A-CSI feedback.

In a fourth operational aspect, the base station uses a set of potential delay periods that is generated by the union of the delay of multiple CSI processes. That is, the new set Y_M is defined by the union of {Y₁ . . . Yₖ} for the total k CSI processes in M-A-CSI. The selection of the particular delay period to use, Ym′, can be indicated either via higher layer signaling or via DCI. Referring back to FIG. 7, base station 105a forms a new set of potential delay periods that is the union of all of the delay periods associated with each of the A-CSI processes included in the request of M-A-CSI trigger 700. Based on further signaling from base station 105a, UE 115a will select the applied delay period, Ym′, for each of the A-CSI processes for the M-A-CSI feedback.

When the selected delay period, Ym′, is not long enough to complete processing on some of the A-CSI processes within the M-A-CSI, the CSI feedback delay may fail to meet the minimum requirement of one or more of the CSI feedbacks within M-A-CSI. For example, with reference to FIG. 7, as the delay period, Ym′, expires, if UE 115a has not completed processing of each of the A-CSI processes of M-A-CSI trigger 700 by 703, the CSI feedback associated with such A-CSI processes fails. When this occurs, the CSI feedback may be “relaxed” for those CSI processes. That is, when the CSI feedback delay of M-A-CSI is selected as X, where the minimum CSI feedback delay required for the j^{th} CSI process is Yⱼ, and X<Yⱼ, then the j^{th} CSI process may be relaxed. Relaxation may include multiple options, such as UE 115a feeding back the previous A-CSI feedback associated with the A-CSI process. Alternatively, UE 115a may simply skip the feedback of that particular CSI process, which may include skipping all CSI feedback components of the associated CSI process.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 5 and 6 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (AMC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method of wireless communications, comprising:
receiving a request to generate multiple aperiodic channel state information (M-A-CSI) feedback;
selecting a delay period for transmission of the M-A-CSI feedback after the request, wherein the delay period is selected from a plurality of delay periods corresponding to a plurality of A-CSI processes of the M-A-CSI feedback;
generating the M-A-CSI feedback; and
transmitting the M-A-CSI feedback to a base station after expiration of the delay period from the request.

2. The method of claim 1, wherein the selecting the delay period includes:
receiving an indication from the base station, wherein the indication identifies an A-CSI process of the plurality of A-CSI processes; and
selecting the delay period corresponding to the A-CSI process.

3. The method of claim 1, wherein the selecting the delay period includes:
identifying a maximum delay period of the plurality of delay periods; and
selecting the maximum delay period as the delay period.

4. The method of claim 1, wherein the selecting the delay period includes:
receiving a set of delay periods corresponding to an intersection of the plurality of delay periods; and
receiving an indication from the base station, wherein the indication identifies the delay period from the set of delay periods.

5. The method of claim 1, wherein the selecting the delay period includes:
receiving a set of delay periods corresponding to a union of the plurality of delay periods; and
receiving an indication from the base station, wherein the indication identifies the delay period from the set of delay periods.

6. The method of claim 1, further including:
detecting a failure to complete processing on one or more A-CSI processes of the plurality of A-CSI processes by expiration of the delay period; and
relaxing feedback parameters associated with the one or more A-CSI processes in response to the failure.

7. The method of claim 6, wherein the relaxing the feedback parameters includes one of:
setting a feedback result of the one or more A-CSI processes to a previous feedback result of the one or more A-CSI processes, wherein the previous feedback result is added to the M-A-CSI feedback; or
skipping all feedback components of the one or more A-CSI processes from the M-A-CSI feedback.

8. The method of claim 1, wherein the plurality of delay periods is received semi-statically.

9. (canceled)

10. An apparatus configured for wireless communications, comprising:
means for receiving a request to generate multiple aperiodic channel state information (M-A-CSI) feedback;
means for selecting a delay period for transmission of the M-A-CSI feedback after the request, wherein the delay period is selected from a plurality of delay periods corresponding to a plurality of A-CSI processes of the M-A-CSI feedback;
means for generating the M-A-CSI feedback; and
means for transmitting the M-A-CSI feedback to a base station after expiration of the delay period from the request.

11. The apparatus of claim 10, wherein the means for selecting the delay period includes one of:
means for receiving an indication from the base station, wherein the indication identifies an A-CSI process of the plurality of A-CSI processes and means for selecting the delay period corresponding to the A-CSI process;
means for identifying a maximum delay period of the plurality of delay periods, and means for selecting the maximum delay period as the delay period;
means for receiving a set of delay periods corresponding to an intersection of the plurality of delay periods, and means for receiving an indication from the base station, wherein the indication identifies the delay period from the set of delay periods; or
means for receiving a set of delay periods corresponding to a union of the plurality of delay periods, and means for receiving an indication from the base station, wherein the indication identifies the delay period from the set of delay periods.

12. The apparatus of claim 10, further including:
means for detecting a failure to complete processing on one or more A-CSI processes of the plurality of A-CSI processes by expiration of the delay period; and
means for relaxing feedback parameters associated with the one or more A-CSI processes in response to the failure.

13. The apparatus of claim 12, wherein the means for relaxing the feedback parameters includes one of:
means for setting a feedback result of the one or more A-CSI processes to a previous feedback result of the one or more A-CSI processes, wherein the previous feedback result is added to the M-A-CSI feedback; or
means for skipping all feedback components of the one or more A-CSI processes from the M-A-CSI feedback.

14. The apparatus of claim 10, wherein the plurality of delay periods is received semi-statically.

15. (canceled)

16. A non-transitory computer-readable medium having program code recorded thereon, the program code comprising:
program code executable by a computer for causing the computer to receive a request to generate multiple aperiodic channel state information (M-A-CSI) feedback;
program code executable by the computer for causing the computer to select a delay period for transmission of the M-A-CSI feedback after the request, wherein the delay period is selected from a plurality of delay periods corresponding to a plurality of A-CSI processes of the M-A-CSI feedback;
program code executable by the computer for causing the computer to generate the M-A-CSI feedback; and
program code executable by the computer for causing the computer to transmit the M-A-CSI feedback to a base station after expiration of the delay period from the request.

17. The non-transitory computer-readable medium of claim 16, wherein the program code executable by the computer for causing the computer to select the delay period includes one of:
program code executable by the computer for causing the computer to receive an indication from the base station, wherein the indication identifies an A-CSI process of the plurality of A-CSI processes, and program code executable by the computer for causing the computer to select the delay period corresponding to the A-CSI process;
program code executable by the computer for causing the computer to identify a maximum delay period of the plurality of delay periods, and program code executable by the computer for causing the computer to select the maximum delay period as the delay period;
program code executable by the computer for causing the computer to receive a set of delay periods corresponding to an intersection of the plurality of delay periods, and program code executable by the computer for causing the computer to receive an indication from the base station, wherein the indication identifies the delay period from the set of delay periods; or
program code executable by the computer for causing the computer to receive a set of delay periods corresponding to a union of the plurality of delay periods, and program code executable by the computer for causing the computer to receive an indication from the base station, wherein the indication identifies the delay period from the set of delay periods.

18. The non-transitory computer-readable medium of claim 16, further including:
program code executable by the computer for causing the computer to detect a failure to complete processing on one or more A-CSI processes of the plurality of A-CSI processes by expiration of the delay period; and
program code executable by the computer for causing the computer to relax feedback parameters associated with the one or more A-CSI processes in response to the failure.

19. The non-transitory computer-readable medium of claim 18, wherein the program code executable by the computer for causing the computer to relax the feedback parameters includes one of:
program code executable by the computer for causing the computer to set a feedback result of the one or more A-CSI processes to a previous feedback result of the one or more A-CSI processes, wherein the previous feedback result is added to the M-A-CSI feedback; or
program code executable by the computer for causing the computer to skip all feedback components of the one or more A-CSI processes from the M-A-CSI feedback.

20. The non-transitory computer-readable medium of claim 16, wherein the plurality of delay periods is received semi-statically.

21. (canceled)

22. An apparatus configured for wireless communication, the apparatus comprising:
at least one processor; and
a memory coupled to the at least one processor,
wherein the at least one processor is configured:
to receive a request to generate multiple aperiodic channel state information (M-A-CSI) feedback;
to select a delay period for transmission of the M-A-CSI feedback after the request, wherein the delay period is selected from a plurality of delay periods corresponding to a plurality of A-CSI processes of the M-A-CSI feedback;
to generate the M-A-CSI feedback; and
to transmit the M-A-CSI feedback to a base station after expiration of the delay period from the request.

23. The apparatus of claim 22, wherein the configuration of the at least one processor to select the delay period includes configuration of the at least one processor:
to receive an indication from the base station, wherein the indication identifies an A-CSI process of the plurality of A-CSI processes; and
to select the delay period corresponding to the A-CSI process.

24. The apparatus of claim 22, wherein the configuration of the at least one processor to select the delay period includes configuration of the at least one processor:
to identify a maximum delay period of the plurality of delay periods; and
to select the maximum delay period as the delay period.

25. The apparatus of claim 22, wherein the configuration of the at least one processor to select the delay period includes configuration of the at least one processor:
to receive a set of delay periods corresponding to an intersection of the plurality of delay periods; and
to receive an indication from the base station, wherein the indication identifies the delay period from the set of delay periods.

26. The apparatus of claim 22, wherein the configuration of the at least one processor to select the delay period includes configuration of the at least one processor:
to receive a set of delay periods corresponding to a union of the plurality of delay periods; and
to receive an indication from the base station, wherein the indication identifies the delay period from the set of delay periods.

27. The apparatus of claim 22, further including configuration of the at least one processor:
to detect a failure to complete processing on one or more A-CSI processes of the plurality of A-CSI processes by expiration of the delay period; and
to relax feedback parameters associated with the one or more A-CSI processes in response to the failure.

28. The apparatus of claim 27, wherein the configuration of the at least one processor to relax the feedback parameters includes configuration of the at least one processor to one of:
set a feedback result of the one or more A-CSI processes to a previous feedback result of the one or more A-CSI processes, wherein the previous feedback result is added to the M-A-CSI feedback; or
skip all feedback components of the one or more A-CSI processes from the M-A-CSI feedback.

29. The apparatus of claim 22, wherein the plurality of delay periods is received semi-statically.

30. (canceled)
